(19) United States
(12) Patent Application Publication
(10) Pub. No.: US 2005/0285360 A1
(43) Pub. Date: Dec. 29, 2005

(54) Method for providing tamper evident system for portable carts

(75) Inventors: Donna R. Helin, Bloomington, MN (US); Charles Rick, Roslyn, NY (US); Richard D. Grass, Apple Valley, MN (US)

Correspondence Address: Merchant & Gould P.C., P.O. Box 2903, Minneapolis, MN, 55402-0903, US

(73) Assignee: Genpak LLC

(21) Appl. No.: 10/875,594

(22) Filed: Jun. 23, 2004

(51) Int. Cl. B62D 39/00

(52) U.S. Cl. 280/47.34

(57) ABSTRACT

A method for securing a portable cart includes wrapping a band around the cart sufficiently tight to prevent access to the cart. The band is then secured to the cart. In preferred methods, the cart is a food service cart on an airplane. The band can include a flexible plastic band with a pair of regions of adhesive covered with removable cover strips.

### TECHNICAL FIELD

This disclosure relates to methods for providing tamper evident systems for portable carts. In particular, this disclosure relates to methods for securing portable carts, such as airline food carts, using a flexible plastic band.

### BACKGROUND

Food service carts in airplanes are used to store food and beverages for providing service to passengers in-flight. Food service carts can also be used to store liquor or items of value for duty-free sale during international flights.

It is conceivable that weapons, bombs, or terrorist contraband could be smuggled aboard an airplane in a food service cart.

What is needed is a quick and convenient system for ensuring that once a food cart has been stocked with its intended supply of food, beverages, or other items for duty-free sale, the cart has not been tampered with. Consequently, there is a need for a way to enhance the safety and protection of portable carts, such as food carts, loaded onto an airplane. There is also a need for a way to ensure the security of the carts, either filled or empty, from unauthorized access.

### SUMMARY

This disclosure is directed to methods for securing portable items. To achieve the advantages and in accordance with the purposes, as embodied and broadly described herein, a method for securing a portable item, such as a cart, includes wrapping a band around the portable item, and then securing the band to the item. In preferred embodiments, the portable item is a cart having a chassis defining an interior and a selectively moveable door to provide access to the interior. The method includes wrapping a band around the cart and over the door sufficiently tight to prevent the door from moving relative to the chassis. The band is then secured to the cart.

Preferably, the method includes wrapping a flexible plastic band around the cart and using adhesive to hold the flexible plastic band in place around the cart.

In preferred methods, the step of securing includes peeling a removable cover strip from the flexible plastic band to expose a first section of adhesive on the flexible plastic band and then pressing the first section of adhesive against the cart to anchor the band for wrapping. Preferably, no permanent seal is created by the contact between the band and the cart. Preferably, a second removable cover strip is peeled from the flexible plastic band to expose a second section of adhesive, and then the second section of adhesive is pressed against the flexible plastic band. This becomes a permanent seal that cannot be pulled apart.

In preferred methods, the steps of wrapping and securing are completed without the use of tools (that is, the steps are completed tool-free).

In preferred methods, the door of the cart includes a projecting handle defining a through-hole. The step of wrapping a band around the cart includes placing the band through the through-hole in the handle.

In preferred methods, after the step of securing, in order to access the contents of the cart, the band is broken to permit moving the door relative to the chassis. The step of breaking the band can include breaking the band along a weakened region of the band. Preferably, the weakened region is a perforated region, a laser cut region, or a die-cut region.

It is to be understood that both the foregoing general description and the following detailed description are exemplary and explanatory only, and are not restrictive of the invention, as claimed.

### BRIEF DESCRIPTION OF THE DRAWINGS

FIG. 1 is a schematic, plan view of a band useable in the method of the invention, the band being shown with a portion of its length broken away;

FIG. 2 is a schematic, perspective view illustrating the band of FIG. 1 used to secure a portable cart, in accordance with principles of this disclosure;

FIG. 3 is an enlarged front elevational view of a portion of the band securing the cart, illustrated in FIG. 2; and

FIG. 4 is a schematic, front elevational view illustrating a secured portable cart, in accordance with principles of this disclosure.

### DETAILED DESCRIPTION

Reference will now be made in detail to preferred embodiments of methods, systems, and apparatus, example of which are illustrated in the accompanying drawings.

In accordance with principles of this disclosure, the invention includes a method for securing portable items, such as portable carts. The portable items have a storage chamber that is accessible by a moveable cover, door, drawer, etc. The method includes wrapping a band around the portable item and over the cover, door, or drawer sufficiently tight to prevent the cover, door, or drawer from moving and to prevent access to the storage interior. The band is then secured to the portable item. In particularly preferred methods, the method is used to secure a food service cart on an airplane. One way this is done is by wrapping a flexible plastic band around the cart and securing the band to the cart through the use of adhesive. In preferred methods, the adhesive used is an adhesive that does not leave any permanent markings. In preferred methods, the method can be practiced without having to rely on any external equipment or tools.

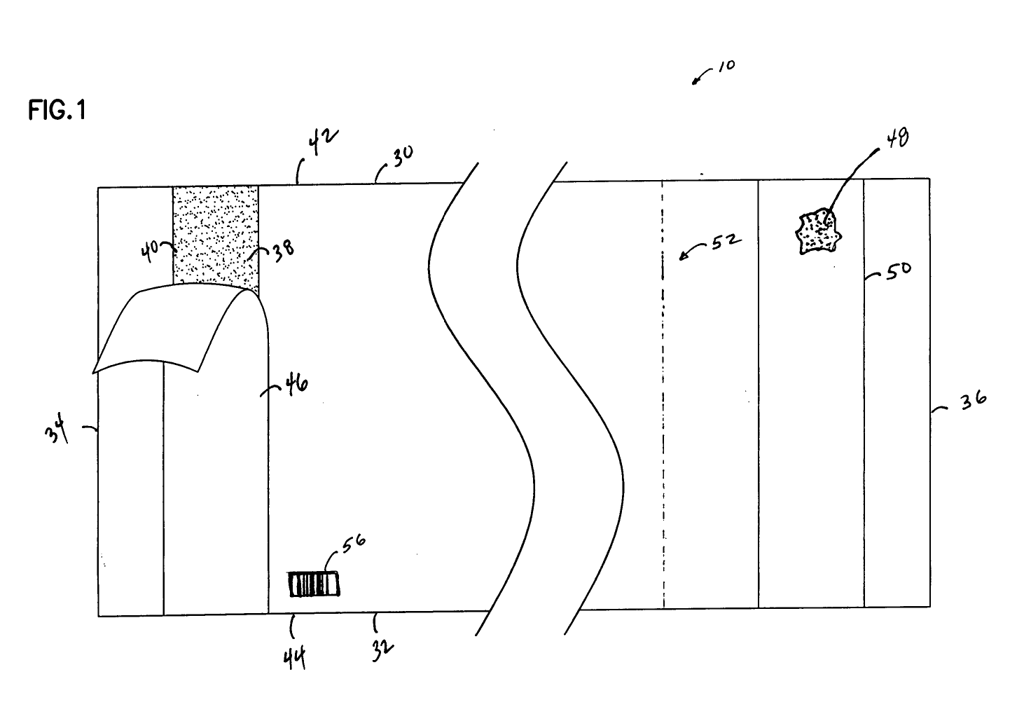

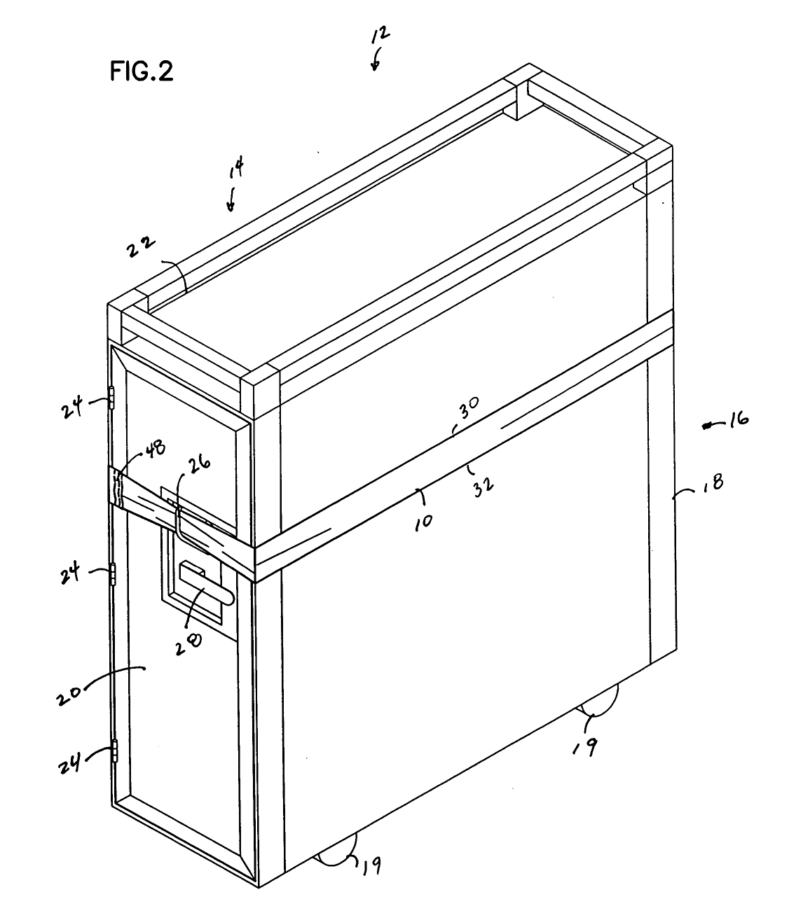

Turning first to FIG. 1, one embodiment of a band useable in methods of this disclosure is depicted, schematically, with a portion of its length removed for clarity, at 10. FIG. 2 depicts the band 10 as positioned in use to secure a portable item 12. In FIG. 2, the portable item 12 is a portable cart 14.

In FIG. 2, the cart 14 can be a food service cart 16 of a conventional, prior art design used by most airlines. The cart 16 includes a six-sided cabinet 18 having at least one moveable door 20. In many carts 16, there is an additional door on the opposite side of the cabinet 18. The cabinet 18 has a generally framework or chassis 22, defining an interior within the cabinet 18. The interior is useable for the storage of, for example, food, beverages, merchandise for sale, etc. The door 20 is moveable relative to the chassis 22 in order to allow access to the interior. As can be seen in FIG. 2, the door 20 in the embodiment shown is secured to the chassis by way of hinges 24. The cart 14 includes wheels or casters 19 to allow for enhanced portability.

Secured to the door 20 is a handle 26 and a latch 28. To gain access to the interior of the cabinet 18, the latch 28 is manipulated to release the door 20 from the chassis 22. Then, the handle 26 is grasped, and the door 20 is pivoted about the hinges 24 to selectively move the door 20 from the chassis 22 and allow access to the interior of the cabinet 18.

In FIG. 2, the band 10 can be seen in its secured position. The band 10 is wrapped around the cart 16 including over the door 20 sufficiently tight to prevent the door 20 from moving relative to the chassis 22. If the latch 28 were put in the released position and the handle 26 grasped, the band 10 would prevent the door 20 from being able to move relative to the chassis 22. That is, the band 10 would prevent the door 20 from pivoting about the hinges 24, and thereby block access to the interior of the cabinet 18.

In reference again to FIG. 1, one example embodiment of band 10 useable in the preferred methods is illustrated. The band 10 is embodied in the form of a flexible strip 30. By “flexible”, it is meant that the strip 30 is moveable with little force (under 20 lbs.), and in some embodiments, is not self-supporting. In one example embodiment, the flexible strip 30 comprises a flexible plastic band, made from, for example, a polymeric material or film.

The band 10 can be made into a variety of geometrical configurations. In the embodiment illustrated, the band 10 includes an elongated rectangular member 32 having elongated parallel edges 42, 44, and first and second ends 34, 36. While the band 10 shown is rectangular 32 having two pairs of parallel sides or edges, of course, the sides or edges can have other geometric shapes or patterns, depending upon the resulting application.

The band 10 includes features to allow for the quick and convenient securing of the band 10 to the cart 14. In the embodiment shown, the band 10 includes adhesive mechanisms to allow for quick and convenient adhering of the band 10 to the cart 14. In FIG. 1, the securing system includes at least a first section of adhesive 38. The first section of adhesive 38 can be oriented along any portion of the band 10 that is convenient, and dependent upon the ultimate application. In the one shown, the first section of adhesive 38 is oriented adjacent to the first end 34. In this embodiment, “adjacent” means less than 10 inches, for example 0-6 inches, and typically 0.25-3 inches from the first end 34. The first section of adhesive 38 is illustrated as a rectangular band 40 running between elongated edge 42 and opposite elongated edge 44.

Preferably, the first section of adhesive 38 includes a removable cover strip 46. The cover strip 46 is peelable to selectively expose the first section of adhesive 38, when it is desired to secure the band 10 to the cart 14. In the embodiment in FIG. 1, the strip 46 is illustrated as having the same shape as the shape of the first section of adhesive 38. As such, the cover strip 46 extends between edge 42 and edge 44. In this embodiment, the cover strip 46 is also located adjacent to the first end 34. In use, the cover strip 46 is peeled away from the first section of adhesive 38. The cover strip 46 is disposed of, and the band 10 is secured to the cart 14 by pressing the first section of adhesive 38 onto the desired portion of the cart 14. Preferably, the contact between the band 10 and cart 14 is not a permanent seal—it is removably secured to allow it to anchor the band 10 to the cart 14 for wrapping.

In preferred embodiments, the band 10 further includes a second section of adhesive 48. The second section of adhesive 48 is shown in FIG. 1 behind a broken away portion of a second removable cover strip 50. The second section of adhesive 48 is illustrated as being adjacent to the second end 36. In this context, adjacent means less than 10 inches, for example 0-6 inches, typically 0.25-3 inches from the second end 36. The second cover strip 50 can be peeled away to expose the second section of adhesive 48 at the desired time. For example, in use, the first section of adhesive 38 is exposed by peeling the cover strip 46 from the band 10 and is secured to the cart 14. Next, the band 10 is wrapped around the cart 14. After the band 10 has been wrapped around the cart 14, the second cover strip 50 is removed to expose the second section of adhesive 48. The end 36 is then secured by pressing the second section of adhesive 48 against either the cart 14, the band 10, or portions of both. Preferably, the band 10 is only secured to itself at the second section of adhesive to create a permanent, non-removable seal 49 between different sections of the band.

In some embodiments, the method includes a way of facilitating the quick and easy removal of the band 10 and allow for tamper-indication. By tamper-indication, it is meant that once the band 10 is removed from the cart 14, the visual appearance of the band 10 will be sufficient to inform the observer that the band 10 has been once secured and was subsequently removed or changed. In the embodiment shown, the band 10 includes a weakened region 52. The weakened region 52 allows for the band 10 to be easily broken under tension or other types of forces applied to it. The weakened region 52 can include perforations, laser cut regions, or die-cut regions. After the band 10 has been secured to the cart 14, once it is desired to gain access to the interior of the cart 14, the band 10 is broken by applying tension or a pulling force on the band in the area of the weakened region. The band 10 will then break or separate at the weakened region 52. This will allow the door 20 to be opened and access to be gained to the cart 14. In addition, the weakened region 52 allows for the breaking of the band 10 without the use of a scissors or other tools. This allows for quick and easy access. In addition, once the band 10 is broken along the weakened region 52, it will become evident to an observer that the band 10 has been broken. If one attempts to tamper with the cart 14, and the band is broken at weakened region 52, it will be easy to tell by observation if the band 10 was later secured together with tape or glue.

The band 10 can have a variety of sizes, depending upon the application. In typical uses, the band 10 will have a width, between edge 42 and edge 44 of 1-10 inches, typically 2-6 inches.

The band 10 can include material handling features, such as a bar code 56. Bar code 56 can help the airline track the food service cart 16. The band 10 can also be color coded, depending upon a number of different factors such as: contents of the cart 14, intended route of the cart 14, and status (empty or loaded) of the cart 14.

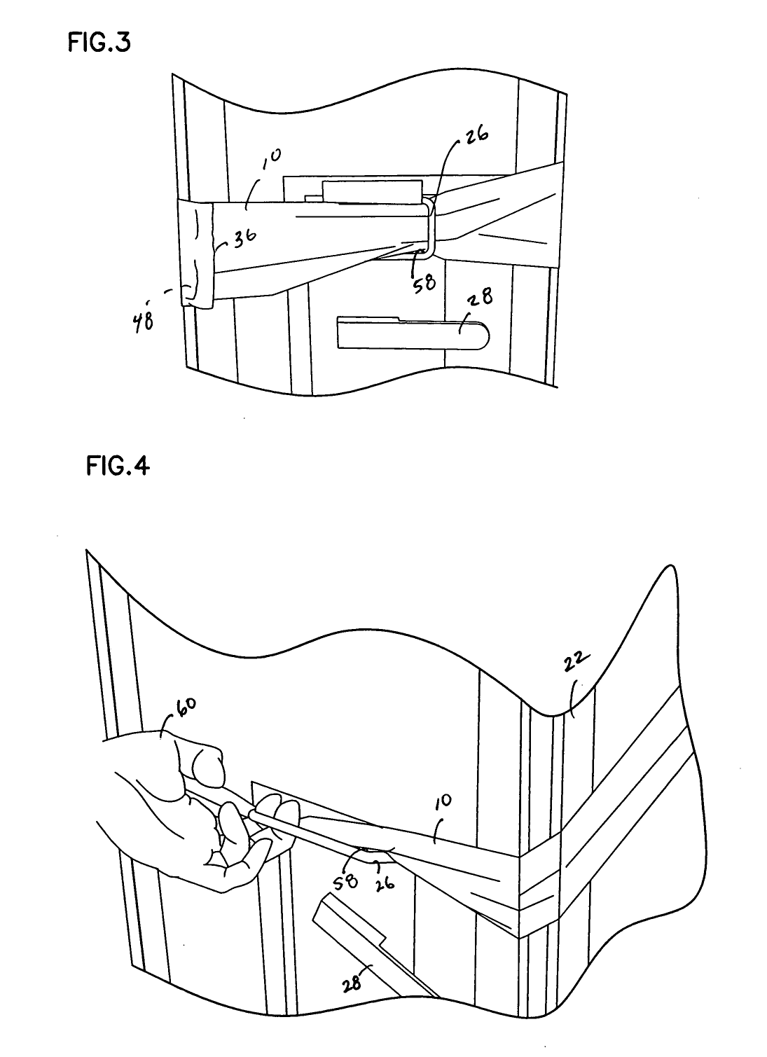

Turning now to FIG. 3, there is an enlarged, front elevational view of the band 10 in use to secure the door 20 in a closed position relative to the chassis 22. The second section of adhesive 48 can be seen, in phantom lines, adjacent to the second end 36. In this embodiment, the second section of adhesive 48 is shown secured to or pressed against the band 10. In certain preferred methods, the handle 26 on the cart 14 defines a through-hole 58. The band 10 is wrapped around the cart 14, including threading or placing the band 10 through the through-hole 58. This helps to keep the band 10 in place relative to the cart 14 and prevent the band 10 from being moved from the cart 14 over the top or bottom edge of the cabinet 18.

FIG. 4 illustrates a person's hand 60 grasping the handle 26. The band 10 is sufficiently strong that it prevents the door 20 from moving relative to the chassis 22.

In use, a method for securing the cart 14 includes wrapping the band 10 around the cart 14 and over the door 20 sufficiently tight to prevent the door 20 from moving relative to the chassis 22. The band 10 is then secured to the cart 14. The securing step includes removing the first cover strip 46 to expose the first section of adhesive 38. The band 10 is secured to the cart by pressing the first section of adhesive 38 against the cart 14. The band is then wrapped around the cart 14, including placing the band 10 through the through-hole 58 of the handle 26. After the band 10 is wrapped around the cart 14, the second cover strip 50 is removed from the band 10 to expose the second section of adhesive 48. The second section of adhesive 48 is pressed against the band 10 to form permanent seal 49 and secure the band 10 in place. It should be appreciated that this entire method is conducted without the use of tools, and is tool-free.

When it is time to access the interior of the cart, the band 10 is removed from the cart. This can be done by breaking the band 10. The band 10 can be broken by breaking it along weakened region 52. Again, this can be conducted under normal hand-force and without the use of a scissors, a knife, or other tools.

One example band 10 has the following properties: it can be made from a blend of low density polyethylene and linear low density polyethylene. The low density polyethylene has a melt index of 1.0 g/10 min.; a vinyl acetate content of 4.0%; a dart drop impact strength of 140 g; a tensile strength at break of 3,700 psi; an elongation at break of 340%; a 1% secant modulus of 21,000 psi; and an Elmendorf tear strength of 180 g. The linear low density polyethylene has the following properties: a melt index of 1.0 g/10 min; a density of 0.918 g/cc; a tensile strength at break of 8,100 psi; an elongation at break of 580%; a 1% secant modulus of 29,000 psi; and an Elmendorf tear strength of 325 g. Such materials can be obtained from Equistar Chemicals, LP of Houston, Tex.

A useful adhesive includes a double coated polyester film tape that incorporates a 100% plastic film release liner. The backing can be a clear polyester film. The adhesive can be a clear synthetic co-polymer, of a high tack permanent type. The liner can be 45 lb., 3 mil, polypropylene, silicone type. One useable adhesive has the following properties: a holding power of 10,000 minutes; a tack of 2 inches; an elongation of 75%; a tensile strength of 22 In; application temperature of 60-120° F.; and a temperature range of −5 to +150° F.

Of course, a wide variety of materials can be used. The above materials and specifications are only examples of some of the types of materials that can be used.

Other embodiments of the invention will be apparent to those skilled in the art from consideration of the specification and practice of the invention disclosed herein. It is intended that the specification and examples be considered as exemplary only.

1. A method for securing a portable cart; the cart having a chassis defining an interior and a selectively moveable door to provide access to the interior; the method comprising:
(a) wrapping a band around the cart and over the door sufficiently tight to prevent the door from moving relative to the chassis; and
(b) securing the band to the cart.

2. A method according to claim 1 wherein:
(a) the step of wrapping includes wrapping a flexible plastic band around the cart.

3. A method according to claim 2 wherein:
(a) the step of securing includes using adhesive to hold the flexible plastic band in place around the cart.

4. A method according to claim 3 wherein:
(a) the step of securing includes:
(i) peeling a first removable cover strip from the flexible plastic band to expose a first section of adhesive on the flexible plastic band;
(ii) pressing the first section of adhesive against the cart;
(iii) peeling a second removable cover strip from the flexible plastic band to expose a second section of adhesive on the flexible plastic band; and
(iv) pressing the second section of adhesive against the flexible plastic band.

5. A method according to claim 4 wherein:
(a) the step of wrapping a band includes wrapping a strip of polymeric material having a width of 1-10 inches.

6. A method according to claim 4 wherein:
(a) the steps of wrapping and securing are completed tool-free.

7. A method according to claim 1 wherein:
(a) the door includes a projecting handle defining a through-hole; and
(b) the step of wrapping a band around the cart includes placing the band through the through-hole in the handle.

8. A method according to claim 4 further comprising:
(a) after the step of securing, breaking the band to permit moving the door relative to the chassis.

9. A method according to claim 8 wherein:
(a) the step of breaking the band includes breaking the band along a weakened region of the band.

10. A method according to claim 9 wherein:
(a) the step of breaking the band along a weakened region includes breaking the band along a perforated region, a laser cut region, or a die cut region.

11. A method according to claim 4 wherein:
(a) the door includes a projecting handle defining a through-hole;
(b) the step of wrapping a band around the cart includes:
(i) placing the band through the through-hole in the handle;
(ii) wrapping a strip of polymeric material having a width of 2-6 inches; and
(c) the steps of wrapping and securing are completed tool-free.
